(19) United States
(12) Patent Application Publication
(10) Pub. No.: US 2015/0274565 A1
(43) Pub. Date: Oct. 1, 2015

(54) Method And Composition For Water Purification And Sludge Dewatering

(71) Applicant: CLARIANT INTERNATIONAL LTD., Muttenz (CH)

(72) Inventors: Gerhard Kummer, Postau (DE); Hans-Georg Hartan, Kevelaer (DE)

(73) Assignee: CLARIANT INTERNATIONAL LTD., Muttenz (CH)

(21) Appl. No.: 14/438,579

(22) PCT Filed: Oct. 22, 2013
(86) PCT No.: PCT/EP2013/072022

§ 371 Date: Apr. 24, 2015

(30) Foreign Application Priority Data
Oct. 26, 2012 (DE) 10 2012 021 103.1

(51) Int. Cl. C02F 11/14; C02F 1/54; C02F 1/38; C02F 1/52

(52) U.S. Cl. CPC C02F 11/14; C02F 1/5263; C02F 1/54; C02F 1/385; C02F 2103/32

(57) ABSTRACT

The invention relates to a method for purifying water and for dewatering sludge, comprising the following steps: bringing a surface-treated natural calcium carbonate, a natural bentonite and an anionic polymer into contact with the water or sludge, flakes being formed as a result of the agglomeration of particulate materials contained in said water or sludge, and separating said formed flakes so as to obtain purified water, or separating water in order to obtain dewatered sludge. The surface-treated natural calcium carbonate is a product of a reaction of natural calcium carbonate with an acid and carbon dioxide, which is formed in situ by the acid treatment and/or is fed from outside, and is produced as an aqueous suspension with a pH greater than 6.0 measured at 20° C. The invention also relates to a composition comprising said surface-treated natural calcium carbonate, a natural bentonite, and an anionic polymer, for the purpose of purifying water or dewatering sludge.

The present invention relates to a method and a composition for purification of water or dewatering sludge.

For waste water purification and sludge dewatering, a method known as flocculation is frequently used. In this case, suspended and colloidal particles are converted into larger particle aggregates using flocculants and flocculation aids, which aggregates are termed “flocs”. These flocs, on account of their size and density, can be separated off from the water in a simple manner by mechanical methods, such as sedimentation or filtration.

As flocculants, predominantly calcium carbonate or milk of lime (Ca(OH)₂), iron (III) salts and aluminum salts are used. These, on account of their positive electric charge, attach themselves to the mostly negatively charged suspended or colloidal particles. This leads to a destabilization of the particles, and owing to the decreased electrostatic repulsion between the particles, to an aggregation to form larger aggregates (coagulation). In addition, the iron and aluminum hydroxides which precipitate out at neutral pHs incorporate suspended or colloidal particles into the flocs that are formed and in this manner contribute to an effective flocculation.

In order to increase the relatively large particle aggregates (microflocs) formed under the influence of the flocculant, usually flocculation aids, such as synthetic polymers (e.g. polyacrylamide) or natural polymers (e.g. starch derivatives) are added. These effect, via ionic or polar interactions, an accumulation, termed “flocculation”, of the microflocs formed to form mechanically separable macroflocs.

In addition to the flocculants and flocculation aids, the use of adsorbents, such as activated carbon, is also known. Adsorbents, on account of the porosity thereof, have a very high (internal) surface area, to which foreign matter or pollutants, such as organic compounds or metal ions, attach and as a result are converted into a mechanically separable form.

In connection with the purification of water, EP 1 974 807 A1 and WO 2008/113839 A1 disclose a special material termed surface-treated, or surface-reacted, natural calcium carbonate (SRCC). This is produced by reacting a natural calcium carbonate (e.g. calcite) with an acid (e.g. hydrochloric acid) and carbon dioxide. The SRCC can be used, preferably in combination with activated carbon, for removing organic compounds (e.g. endocrine-active organic compounds) or inorganic compounds (e.g. heavy metals) from aqueous media. In addition, WO 2008/113840 A1 discloses that said SRCC, together with flocculants/flocculation aids, such as synthetic polymers (e.g. polyacrylamide) or natural polymers (e.g. starch) can be used for purification of water.

In addition, EP 2 011 766 A1 discloses the use of said SRCC in combination with a hydrophobic adsorbent for water treatment. As hydrophobic adsorbent, talcum, hydrophobized calcium carbonate, hydrophobized bentonite, hydrophobized kaolinite or hydrophobized glass can be used. In addition, after addition of the SRCC and the hydrophobic adsorbent, optionally a polymeric flocculant/flocculation aid (e.g. polyacrylamide or starch) can be added to the water that is to be purified.

In the case of the known methods for water purification or sludge dewatering based on flocculation, the floc formation and therefore the removal of suspended or colloidal particles, however, could still be improved. Also, the simultaneous removal of suspended and colloidal particles and dissolved organic or inorganic foreign matter or pollutants (e.g. heavy metals and aromatic hydrocarbons) is frequently unsatisfactory. In addition, the use of an adsorbent for removing said unwanted organic or inorganic foreign matter or pollutants is frequently associated with the disadvantage that, after the adsorption process, on account of their finely distributed state, they are only removable with difficulty. In addition, as flocculation aids, generally polyacrylamides are used which, however, have very poor biodegradability, and have a high aquatic toxicity. For this reason, there is great interest in effective flocculation methods which succeed without ecologically hazardous polyacrylamides.

The object of the invention was therefore to provide a method with which, in a simple and efficient manner, suspended or colloidal particles and also dissolved organic and inorganic foreign matter or pollutants can be removed from water that is to be purified, or with which, a sludge that is to be dewatered can be dewatered with simultaneous binding of foreign matter or pollutants, with a dry matter content as high as possible being obtained. In addition, the method should also be able to be operated using readily biodegradable polymers.

This object is achieved by the technical teaching cited in claims 1, 12 and 14. Advantageous embodiments result from the subclaims.

A first subject matter of the present invention is accordingly a method for purification of water or for dewatering sludge, which comprises the following steps:
(a) contacting a surface-treated natural calcium carbonate, a natural bentonite and an anionic polymer with the water or the sludge, wherein, by aggregation of the particulate substances present in the water or the sludge, flocs are formed, and
(b) separating off the flocs formed, in order to obtain purified water or separating off water, in order to obtain a dewatered sludge.

The surface-treated natural calcium carbonate that is usable according to the invention is a reaction product of a natural calcium carbonate with an acid and carbon dioxide which is formed in situ by the acid treatment and/or is supplied externally, and is produced as an aqueous suspension having a pH, measured at 20° C., of more than 6.0.

It has surprisingly been found that using a combination of a surface-treated natural calcium carbonate, a natural bentonite and an anionic polymer leads to excellent purification of water and of excellent dewatering of sludge. When said combination is used, large flocs are formed which sediment well. The flocs are in addition sufficiently stable, such that they can be mechanically separated off in a simple manner. In addition, at the same time as the suspended and colloidal particulate substances, dissolved foreign matter or pollutants, such as metals, for example, can also be separated off.

In addition, the method according to the invention is functional even without significant restrictions of performance when a natural anionic polymer is used instead of the ecologically harmful polyacrylamides currently predominately used as flocculation aids. A further advantage is that the chemicals used in the present invention, i.e. the calcium carbonate, the bentonite and the polymer, are all inexpensive and simple to handle, as a result of which an inexpensive and simple method for water purification or sludge dewatering can be provided.

In the step (a) of the method according to the invention, first a surface-treated natural calcium carbonate, as defined above, a natural bentonite and an anionic polymer are contacted with the water or the sludge. The “water” used in the method according to the invention that is to be purified can be process water, drinking water or waste water. The expression “process water” used herein refers to water which serves for a certain industrial, commercial, agricultural or domestic use. In contrast to drinking water, for process water, generally drinking water quality is not required. The expression “waste water” used here designates not only the water contaminated through use such as, for example, industrial waste water, communal waste water, waste water from breweries or other drinks industries, screen water and waste water of the papermaking industry and agricultural waste water, but also water which contains foreign matter or pollutants, for example water of precipitation flowing off from consolidated surfaces, and water from refuse landfills.

The “sludge” which is to be dewatered by means of the method according to the invention is a system consisting of liquid (mostly water) and suspended or colloidal particulate substances. A sludge differs from the water that is to be purified according to the present invention in particular in that the sludge, in addition to the solids, consists of a relatively small amount of water. The sludge that is to be dewatered preferably comprises sewage sludges, beet water sludges, sediments of natural waters and harbors, sludges from geological boreholes and the slurry wall construction method, papermaking sludges, oil-containing sludges, for example from crude oil extraction, in particular oil sand, and industrial sludges, for example sludges from the food industry or aluminum hydroxide-containing sludges. The purpose of the method for sludge dewatering is to obtain sludge having a dry matter content as high as possible, using substantially natural materials (bentonite, calcium carbonate, derivatives of natural polymers such as, for example, galactomannan, chitosan, or on the basis of starch, and optionally readily biodegradable polymers (for example polyacrylates).

As surface-treated natural calcium carbonate, a special calcium carbonate termed “surface-reacted natural calcium carbonate” (SRCC) is used according to the present invention. This is described, inter alia, in the patent application EP 2 011 766 A1, the contents of which are hereby incorporated into the present application. According thereto, the surface-treated natural calcium carbonate is a reaction product of a natural calcium carbonate with an acid and carbon dioxide which is formed in situ by the acid treatment and/or is supplied externally, and wherein the surface-treated natural calcium carbonate is produced as an aqueous suspension having a pH measured at 20° C. of more than 6.0.

Preferably, the natural calcium carbonate is selected from marble, calcite, chalk, dolomite, limestone or mixtures thereof. According to a preferred embodiment, the natural calcium carbonate, before the treatment with an acid and carbon dioxide, is comminuted. The comminution step can be carried out with any conventional device, such as a milling apparatus known to those skilled in the art.

The aqueous suspension is preferably produced by suspending in water the natural calcium carbonate which is optionally present in finely divided form (e.g. by milling). Preferably, the slurry has a natural calcium carbonate content in the range from 1 to 80% by weight, preferably 3 to 60% by weight, and particularly preferably 5 to 40% by weight, based on the weight of the slurry.

In a next step, the acid is added to the aqueous suspension which contains the natural calcium carbonate. Alternatively, it is also possible to add the acid to the water before suspension of the natural calcium carbonate. Preferably, the acid has a pKₐ at 25° C. of 2.5 or less. If the pKₐ at 25° C. is less than or equal to zero, the acid is preferably selected from sulfuric acid (H₂SO₄), hydrochloric acid (HCl) or mixtures thereof. If the pKₐ at 25° C. is in the range from 0 to 2.5, the acid is preferably selected from sulfurous acid (H₂SO₃), monodeprotenated sulfuric acid (HSO₄⁻), phosphoric acid (H₃PO₄), oxalic acid (HOC(O)C(O)OH) or mixtures thereof. The acid(s) can be added as concentrated solution or dilute solution. Preferably, the molar ratio of acid to the natural calcium carbonate is 0.05 to 4, preferably 0.1 to 2.

Next, the natural calcium carbonate is treated with carbon dioxide. The carbon dioxide can be formed in situ by the acid treatment, and/or be supplied externally. If a strong acid, such as sulfuric acid or hydrochloric acid, is used for the acid treatment of the natural calcium carbonate, the carbon dioxide is automatically formed. In this case, the acid treatment and the treatment with carbon dioxide occur simultaneously. It is also possible to carry out the acid treatment first, for example using a medium-strength acid having a pKₐ in the range from 0 to 2.5, followed by a treatment from externally supplied carbon dioxide. In addition, the acid treatment step and/or the carbon dioxide treatment step can also be repeated at least once, in particular several times.

Preferably, the concentration of gaseous carbon dioxide in the suspension, based on the volume, is such that the ratio (volume of suspension):(volume of gaseous CO₂) is 1:0.05 to 1:20, more preferably 1:0.05 to 1:5.

As mentioned above, the surface-treated natural calcium carbonate is produced as an aqueous suspension having a pH, measured at 20° C., of more than 6.0. This means that the calcium carbonate reacted with an acid and carbon dioxide is provided in the form of a suspension having a pH, measured at 20° C., of more than 6.0. The surface-treated natural calcium carbonate provided need not, however, be used in the form of such a suspension in the method according to the invention, it can, rather after further steps be used in any other suitable form, for example in the form of a powder.

The pH, measured at 20° C., reached after the acid treatment and the carbon dioxide treatment, is naturally more than 6.0, preferably more than 6.5, more preferably more than 7.0, particularly preferably more than 7.5, as a result of which the surface-treated natural calcium carbonate is provided as an aqueous suspension having a pH, measured at 20° C., of more than 6.0, preferably more than 6.5, more preferably more than 7.0, particularly preferably more than 7.5. If the aqueous suspension can reach equilibrium, the pH is more than 7.

A pH of more than 6.0 can be set without adding a base, if the stirring of the aqueous suspension is continued for a sufficient time span, preferably 1 to 10 hours, more preferably 1 to 5 hours. Alternatively, the pH of the aqueous suspension before equilibrium is reached, which is the case at a pH of more than 7, can be increased to more than 6 by adding a base after the carbon dioxide treatment. For this purpose, any customary base, such as sodium hydroxide or potassium hydroxide can be used. The increase in pH to more than 6.0 after treatment with an acid and carbon dioxide is necessary in order to provide the surface-treated natural calcium carbonate used in the present invention with advantageous properties with respect to adsorption and flocculation.

Using the above-described method steps, i.e. acid treatment, treatment with carbon dioxide and pH adjustment, a surface-treated natural calcium carbonate is obtained which can be used in the present invention. Further details with respect to production of the surface-treated natural calcium carbonate are disclosed in WO 00/39222 A1 and US 2004/0020410 A1, the contents of which are hereby incorporated in the present application.

In a preferred embodiment of the method for producing the surface-treated natural calcium carbonate, the natural calcium carbonate is reacted with the acid and/or the carbon dioxide in the presence of at least one compound selected from the group consisting of silicate, silicon dioxide, aluminum hydroxide, alkaline earth metal aluminate, and also, for example sodium aluminate or potassium aluminate, magnesium oxide or mixtures thereof. Preferably, the at least one silicate is selected from an aluminum silicate, a calcium silicate, a further alkaline earth metal silicate or an alkali metal silicate. These components can be added to an aqueous suspension which comprises the natural calcium carbonate before the acid and/or the carbon dioxide is added. Alternatively, the silicate and/or silicon dioxide and/or aluminum hydroxide and/or alkali metal or alkaline earth metal aluminate and/or magnesium oxide component(s) can be added to the aqueous suspension of natural calcium carbonate, although the reaction of natural calcium carbonate with an acid and carbon dioxide has already started. Further details with respect to the production of the surface-treated natural calcium carbonate in the presence of at least one silicate and/or silicon dioxide and/or aluminum hydroxide and/or alkaline earth metal aluminate component are disclosed in WO 2004/083316, the contents of which are hereby incorporated in the present invention.

Preferably, the surface-treated natural calcium carbonate has a specific surface area from 5 to 200 m²/g, more preferably from 20 to 80 m²/g, and particularly preferably from 30 to 60 m²/g, measured using nitrogen and the BET method as specified in ISO 9277.

In addition, it is preferred that the surface-treated natural calcium carbonate has a weight-average particle diameter, d₅₀, from 0.1 to 50 μm, more preferably from 0.5 to 25 μm, and particularly preferably from 0.7 to 7 μm, measured according to the sedimentation method. The sedimentation method is an analysis of the sedimentation behavior in a gravimetric field. For measuring the weight-average particle diameter, according to the present invention, a Sedigraph™ 5100 from Microtronics is used. The method and the instrument are known to those skilled in the art and are customarily used in order to determine the particle size of fillers and pigments. The measurement proceeds in an aqueous solution of 0.1% by weight Na₄P₂O₇. The samples are dispersed using a high-speed agitator and ultrasound.

The surface-treated natural calcium carbonate preferably has a specific BET surface area in the range from 15 to 200 m²/g, and a weight-average particle diameter in the range from 0.1 to 50 μm. Particularly preferably, the specific BET surface area is 20 to 80 m²/g and the weight-average particle diameter 0.5 to 25 μm. Most preferably, the specific BET surface area is in the range from 30 to 60 m²/g, and the weight-average particle diameter in the range from 0.7 to 7 μm.

Furthermore, the surface-treated natural calcium carbonate preferably has an intraparticle porosity from to 40% by volume, measured by means of mercury porosimetry. For measurement of the intraparticle porosity, according to the present invention, first tablets are made from suspensions of the surface-treated natural calcium carbonate. The tablets are formed by applying a pressure constant for several hours to the suspension/slurry, in such a manner that water is released by filtration through a 0.025 μm thin filter membrane, as a result of which a compressed tablet is obtained. The tablets are then taken out of the apparatus and dried in an oven at 80° C. for 24 hours.

After the drying, individual parts of each tablet are characterized by means of mercury porosimetry with respect to porosity and pore size distribution, using a Mikromeritics Autopore IV mercury porosimeter. The maximally applied mercury pressure is in this case 414 MPa, equivalent to a Laplace pore diameter of 0.004 μm. The mercury penetration measurements were corrected by the compression of mercury, the expansion of the penetrometer and the compressibility of the solid phase of the sample. Further details of the measurement method are described in Transport in Porous Media 61(3):239-259, 2006.

The aqueous suspension of the surface-treated natural calcium carbonate obtained by the above-described method can be added as such to the water or the sludge. Alternatively, the aqueous suspension can be dried and the surface-treated natural calcium carbonate can be contacted in a solid form, for example as powder or granules, with the water or the sludge.

The aqueous suspension can also be modified before the contacting, for example by adjusting the pH to a value suitable for flocculation. In addition, the aqueous suspension can also be a component of a liquid composition which comprises the natural bentonite and/or the anionic polymer. In addition, the surface-treated natural calcium carbonate can be stored as a suspension. Optionally, a dispersant is additionally necessary therefor. As dispersant, a customary anionic or cationic dispersant can be used. A preferred dispersant is polyacrylic acid.

The above-described surface-treated natural calcium carbonate serves in the present invention for destabilizing suspended or colloidal particulate substances by charge exchange, as a result of which the particulate substances coagulate to form larger units. It also acts as adsorbent and participates in the flocculation, i.e. the formation of macroflocs by aggregation of microflocs.

In the method according to the invention, in addition, a natural bentonite is used. This serves for flocculation of suspended or colloidal particles and the adsorption of foreign matter or pollutants. A “bentonite” in the meaning of the present invention designates, in particular, a rock having a content of the clay mineral montmorillonite of at least 50% by weight, preferably at least 60% by weight, in particular more than 70% by weight, and particularly preferably more than 80% by weight. Preferred bentonites include calcium bentonite and sodium bentonite. The expression “natural” used herein refers to a state that occurs in nature. A hydrophobized bentonite is accordingly not a natural bentonite within the meaning of the present invention.

Natural bentonite, in the context of the present invention, can be a neutral or alkaline natural bentonite. Preferably, the natural bentonite is a neutral natural bentonite. A neutral natural bentonite is taken to mean a smectitic sheet silicate, for which a suspension of 2 g/10 ml in water has a pH from 6.0 to 8.0, preferably from 6.5 to 7.5. An alkaline natural bentonite is, in contrast, a natural bentonite for which a suspension of 2 g/10 ml in water has a pH of more than 8.0, preferably from 9.0 to 12.0.

The anionic polymer which is used in addition to the surface-treated natural calcium carbonate and the natural bentonite in the method according to the invention, typically has a mass-average molecular mass of at least 10⁴ g/mol, preferably 10⁴ to 10⁸ g/mol, and particularly preferably 10⁶ to 10⁷ g/mol. The expression “anionic” used herein relates to a polymer having a negative total charge. The anionic polymer serves for flocculation of suspended or colloidal particles present in the water or sludge.

The anionic polymer can be either a synthetic polymer or a natural polymer. Examples of suitable synthetic polymers are negatively charged polyelectrolytes which are based on polyacrylates or polyethyleneimines and mixtures thereof. Polyacrylamides, in particular cationic polyacrylamides, are preferably not used. Suitable natural anionic polymers are, for example, anionized starch, alginate and mixtures thereof.

Anionic starch has proved to be particularly advantageous.

The surface-treated natural calcium carbonate is contacted with the water, preferably in an amount of 0.001 to 0.1% by weight, and particularly preferably in an amount of 0.005 to 0.02% by weight, based on the weight of the water, or with the sludge, preferably in an amount of 0.005 to 20% by weight, and particularly preferably in an amount of 0.5 to 10% by weight, based on the weight of the sludge.

The natural bentonite is contacted with the water, preferably in an amount of 0.0001 to 0.01% by weight, and particularly preferably in an amount of 0.0005 to 0.002% by weight, based on the weight of the water, or with the sludge, preferably in an amount of 0.0005 to 5.0% by weight, and particularly preferably in an amount of 0.05 to 2.0% by weight, based on the weight of the sludge.

The anionic polymer is contacted with the water or the sludge, preferably in an amount from 1×10⁻⁵ to 1×10⁻³% by weight (0.1 to 10 ppm) and particularly preferably in an amount from 0.5×10⁻⁵ to 2.0×10⁻⁴% by weight (0.05 to 2.0 ppm), based on the weight of the water or the sludge.

The invention also includes, in particular, combinations of the preferred and particularly preferred embodiments cited hereinbefore and hereinafter.

According to the invention, the surface-treated natural calcium carbonate, the natural bentonite and the anionic polymer are contacted with the water or the sludge in each case separately from one another in any desired sequence. It is also possible to add the surface-treated natural calcium carbonate combined with the natural bentonite and, separately therefrom, the anionic polymer, in any desired sequence. Also, an addition of the natural bentonite combined with the anionic polymer, preferably both as powder, and separately therefrom, an addition of the surface-treated natural calcium carbonate is conceivable. Preferably, the surface-treated natural calcium carbonate, the natural bentonite and the anionic polymer, however, are contacted separately with the water or the sludge.

The contacting of the surface-treated natural calcium carbonate, the natural bentonite, and the anionic polymer, proceeds in a conventional manner, for example by pouring, or bulk addition or injection. Preferably, the contacting proceeds with mixing, since rapid intermixing beneficially affects the success of flocculation.

Under the influence of the surface-treated natural calcium carbonate, the natural bentonite and the anionic polymer, particulate substances which are present in the water or the sludge congregate to form flocs. The expression “flocs” is taken to mean relatively large aggregates of particulate substances. These form by flocculation from microflocs which, in turn, form by coagulation of suspended or colloidal particulate substances. The expression “particulate substances” used herein comprises colloidal particles which have a particle diameter of less than 1 μm, and suspended particles which have a particle diameter of more than 1 μm. Suspended particles in the meaning of the present invention are accordingly also relatively large suspended or turbid solids.

The speed and the extent of floc formation can be increased by mixing. Accordingly, the floc formation preferably proceeds with mixing. Too high an energy input, for example too high a stirrer speed or stirrer power, however, can lead to high shear forces which cause destruction of the flocs that are forming. This can, as is known to those skilled in the art, be avoided, for example by using two or more flocculation reactors having a decreasing stirrer power.

In addition, the pH of the water or of the sludge after contacting with the surface-treated natural calcium carbonate, the natural bentonite and the anionic polymer is preferably 3.0 to 12.0, more preferably 5.0 to 10.0, and particularly preferably 6.5 to 9.5. A suitable pH has a beneficial effect on the flocculation and can readily be determined by those skilled in the art. If necessary, a desired pH can be set by adding a customary acid, such as hydrochloric acid, and/or a customary base, such as sodium hydroxide.

In step (b) of the method according to the invention, the flocs that are formed are separated off in order to obtain purified water, or water is separated off in order to obtain a dewatered sludge. For the separation, customary methods of liquid/solid separation, such as filtration, sedimentation, centrifugation, decantation or floatation, can be used.

In the case of purification of water, purified water and a residue termed flocculation sludge are obtained. Said residue can be further dewatered by the method according to the invention, thickened using sludge thickeners, or subjected to other treatments. In the dewatering of sludge, for example solids, pollutants, metals, organic suspended fractions and dissolved organic substances in bound form are separated off from water as dewatered sludge. The sludge that is separated off can, if necessary, be further dewatered using the method according to the invention. On account of the increased solids fraction, the dewatered sludge obtained, depending on composition (in particular toxic substances), can be used for various applications. Oil sludge-containing water, for example, can be purified to free it from solids, metals and organic dissolved or insoluble substances. The sludge that is separated off can, in addition, be dewatered using the method according to the invention, wherein the pollutants are bound in the sludge.

The flocculation sludge obtained from the purification of water and the dewatered sludge obtained from the dewatering of sludge, contain all the water components or sludge components removed in the flocculation, the addition of surface-treated natural calcium carbonate, natural bentonite and anionic polymer and optionally further solid water or sludge components which were present in the water or sludge and have likewise been separated off by the separation in step (b) of the method according to the invention.

The method according to the invention permits not only the effective removal of suspended and colloidal particulate substances, such as turbidity substances, from water and sludge, but (heavy) metals, microorganisms (bacteria, fungi, protozoa, viruses) and dissolved organic substances, such as dyes, tannins, humic acid, phenol and polycyclic aromatic hydrocarbons, can also be removed. As (heavy) metals which can be removed by the method according to the invention, mention may be made of, in particular, iron, manganese, cadmium, lead, chromium, nickel and copper. The method according to the invention can therefore be used in a multiplicity of applications.

A further subject matter of the present invention is a composition for purification of water or for dewatering sludge, which comprises an above-described surface-treated natural calcium carbonate, an above-described natural bentonite, and an above-described anionic polymer.

The weight ratio of the surface-treated natural calcium carbonate and the natural bentonite is in the range from 1:99 to 99:1, preferably in the range from 50:50 to 99:1, more preferably in the range from 70:30 to 95:5 and particularly preferably in the range from 80:20 to 90:10. If the composition according to the invention is intended for purification of water, the weight ratio of the surface-treated natural calcium carbonate and the anionic polymer is preferably in the range from 97:3 to 99.98:0.02, more preferably in the range from 99.1:0.9 to 99.9:0.1, and particularly preferably in the range from 99.5:0.5 to 99.8:0.2. In the use for dewatering sludge, the weight ratio of the surface-treated natural calcium carbonate and the anionic polymer is preferably in the range from 98:2 to 99.999:0.001, more preferably in the range from 99:1 to 99.995:0.005, and particularly preferably in the range from 99.9:0.1 to 99.99:0.01.

The composition according to the invention can be present in liquid or solid form. Liquid forms include aqueous suspensions, dispersions or emulsions. Solid forms are, for example, powders, granules and tablets. Preferably, the composition is an aqueous suspension or a powder.

A further subject matter of the present invention is the use of the surface-treated natural calcium carbonate in combination with the natural bentonite and the anionic polymer for purification of water or for dewatering sludge.

According to a preferred embodiment of the present invention, for purification of water, or for dewatering sludge, the above-described composition according to the invention is used.

The present invention will be described in more detail by the examples hereinafter.

### EXAMPLES

### Example 1

### Dewatering of Sludge from Sugar Beet Washing

In this example the flocculation capacity of the surface-treated calcium carbonate, natural bentonite and anionic polymer used in the present invention was studied. For this purpose, the flocculation components shown in table 1 below were used.

TABLE 1
Amount and type of the flocculation
components used

| | No. 1 | No. 2 | No. 3 | No. 4 | No. 5 | No. 6 | No. 7 |
|---|---|---|---|---|---|---|---|
| | (Control) | (Invention) | (Comparison) | (Comparison) | (Comparison) | (Invention) | (Comparison) |
| Surface- | — | 0.45 | — | 0.50 | 0.45 | 0.45 | 0.45 |
| treated | | | | | | | |
| CaCO₃ | | | | | | | |
| (g/l)¹ | | | | | | | |
| Natural | — | — | 0.45 | — | — | — | — |
| CaCO₃ | | | | | | | |
| (g/l)² | | | | | | | |
| Ca | — | 0.05 | 0.05 | — | — | 0.05 | — |
| bentonite | | | | | | | |
| (g/l)³ | | | | | | | |
| Hydrophobic | — | — | — | — | 0.05 | — | 0.05 |
| bentonite | | | | | | | |
| (g/l)⁴ | | | | | | | |
| Anionic | — | 0.2 | 0.2 | 0.2 | 0.2 | — | — |
| polymer | | | | | | | |
| (0.05% | | | | | | | |
| solution) | | | | | | | |
| (ml/l)⁵ | | | | | | | |
| Anion | — | — | — | — | — | 0.2 | 0.2 |
| starch | | | | | | | |
| (0.05% | | | | | | | |
| solution) | | | | | | | |
| (ml/l)⁶ | | | | | | | |

¹MCC R 450 ME (Omya AG)
²CaCO₃, precipitated, (Merk), non-surface-treated in the meaning of the application
³TERRANA (Sud-Chemie AG)
⁴Tixogel VP (Rockwood Additives Ltd.)
⁵Sedipur AF 203 (anionic polyacrylate) (BASF)
⁶Sudfloc A1/S (anionic starch) (Süd-Chemie AG)

The amounts relate to the sludge sample that is to be dewatered. Thus, 0.45 g/l represent 0.45 g of component per 1 l of sludge to be dewatered, which, in the case of a batch size of 200 ml, is equivalent to 0.09 g of component to sludge to be dewatered.

The calcium carbonate, the bentonite and the anionic polymer were added successively with stirring to 200 ml of the sample of the sugar beet sludge that is to be dewatered and stirred for about 10 minutes. Then, the flocculation and the sedimentation were evaluated.

Subsequently, the sludge mixture was filtered and the turbidity of the filtrate, the dry matter content of the filter cake and the dewatering capacity were determined.

For determination of the flocculation, the sedimentation, the turbidity, the dry matter content and the dewatering, the measurement methods described hereinafter were used.

Flocculation

The flocculation was graded as follows (assessment of floc size):

0=none

1=slight

2=average

3=large

4=very large

Sedimentation

The sedimentation was graded as follows (visual assessment in comparison of the samples with one another):

0=none

1=poor

2=average

3=good

4=very good

Turbidity

The turbidity was determined photometrically as specified in ISO 7027 using a HACH 2100P ISO turbidimeter.

Dry Matter Content

The dry matter content was measured as specified in DIN 38414 part 2 at 105° C.

Dewatering

The dewatering was determined by placing the sludge mixture (200 ml of sludge and further components from table 1) into a fluted filter (Watman 595½) and the time until no aqueous supernatant was present any longer on the sludge in the filter was measured. The grading (0 to 4) was performed as follows:

0=>120 s

1=90-120 s

2=60-90 s

3=30-60 s

4=0-30 s

The results shown in table 2 were obtained.

TABLE 2
Results for dewatering of sugar beet sludge

| | No. 1 | No. 2 | No. 3 | No. 4 | No. 5 | No. 6 | No. 7 |
|---|---|---|---|---|---|---|---|
| | (Control) | (Invention) | (Comparison) | (Comparison) | (Comparison) | (Invention) | (Comparison) |
| Flocculation | 0 | 2-3 | 0 | 1 | 1 | 1 | 1 |
| Sedimentation | 0 | 2-3 | 1 | 2 | 1 | 1 | 1 |
| Turbidity | 38.6 | 20 | 35 | 37.3 | 22.1 | 22.6 | 41.5 |
| (FNU) | | | | | | | |
| Dry matter | 27 | 29.9 | 27.1 | 28.9 | 28.4 | 29.3 | 28.1 |
| content of | | | | | | | |
| filter cake | | | | | | | |
| Dewatering | 0 | 3 | 0 | 1 | 1 | 2 | 0 |

These results show that the flocculation components according to the invention achieve the best results, in particular in the dewatering. In addition, the examples according to the invention deliver excellent results with respect to the other parameters.

### Example 2

### Purification of Industrial Waste Water (1)

In this example, the suitability of the combination of the special surface-treated natural calcium carbonate in combination with a natural bentonite and an anionic polymer for removing the metals cadmium, lead and chromium from industrial waste water (waste water from a metal-processing commercial operation) was studied.

Experimental procedure: first, the calcium carbonate together with the bentonite in a 200 ml glass beaker was mixed with 200 ml of waste water and stirred for 60 sec and then admixed with the anionic polymer with further stirring. The stirring time up to sludge separation through the fluted filter was 10 min. The amount and type of the flocculation components used in this example can be found in table 1 in example 1.

The residue of the metals in the purified waste water was determined by means of ICP as specified in DIN EN ISO 11885.

The results are shown in table 3.

TABLE 3
Results regarding removal of cadmium, lead
and chromium from industrial waste water

| | No. 1 | No. 2 | No. 3 | No. 4 | No. 5 | No. 6 | No. 7 |
|---|---|---|---|---|---|---|---|
| | (Control) | (Invention) | (Comparison) | (Comparison) | (Comparison) | (Invention) | (Comparison) |
| Cadmium | 21.4 | 0.062 | 0.071 | 20.2 | 16.5 | 0.06 | 15 |
| (mg/l) | | | | | | | |
| Lead | 0.95 | 0.57 | 0.62 | 0.81 | 0.8 | 0.60 | 0.89 |
| (mg/l) | | | | | | | |
| Chromium | 650 | 192 | 199 | 521 | 345 | 195 | 315 |
| (mg/l) | | | | | | | |

These results show the high efficiency of the flocculation components according to the invention in the removal of certain heavy metals from waste water.

### Example 3

### Purification of Industrial Waste Water (2)

In this example, the suitability of the combination of the surface-treated natural calcium carbonate, a natural bentonite and an anionic polymer for removing the metals nickel and copper from industrial waste water (waste water from a metal-processing commercial operation) was studied.

Experimental procedure: first, the calcium carbonate together with the bentonite in a 200 ml glass beaker was mixed with 200 ml of waste water and stirred for 60 sec and then admixed with the anionic polymer with further stirring. The stirring time up to sludge separation via the fluted filter was 10 min. The amount and type of the flocculation components used in this example can be found in table 1 in example 1.

The residue of the metals in the purified water was determined by means of ICP as specified in DIN EN ISO 11885.

The results are shown in table 4.

TABLE 4
Results regarding the removal of nickel and
copper from industrial waste water

| | No. 1 | No. 2 | No. 3 | No. 4 | No. 5 | No. 6 | No. 7 |
|---|---|---|---|---|---|---|---|
| | (Control) | (Invention) | (Comparison) | (Comparison) | (Comparison) | (Invention) | (Comparison) |
| Nickel | 180 | 0.1 | 0.1 | 153 | 23 | 0.1 | 45 |
| (mg/l) | | | | | | | |
| Copper | 26.9 | 5.1 | 5.8 | 7.1 | 5.8 | 5.2 | 2.8 |
| (mg/l) | | | | | | | |

These results show the high efficiency of the flocculation components according to the invention in the removal of certain heavy metals from waste water.

### Example 4

### Purification of Synthetic Waste Water

In this example, the suitability of the special surface-treated natural calcium carbonate in combination with a natural bentonite and an anionic polymer for removing the metals iron and manganese from synthetic waste water (produced by adding 40 mg/l of iron chloride to a water sample from Hamburg harbor) was studied.

Experimental procedure: first, the calcium carbonate together with the bentonite in a 200 ml glass beaker were mixed with 200 ml of waste water and stirred for 60 sec and then admixed with the anionic polymer with further stirring. The stirring time up to sludge separation via the fluted filter was 10 min. The amount and type of flocculation components used in this example can be found in table 1 in example 1, wherein, in the present example 4, as anionic polymer Nerolan AG 580 (Nerolan Wassertechnik GmbH Krefeld) was used in an amount of 1.5 mg/l.

The residue of the metals in the purified waste water was determined by means of ICE as specified in DIN EN ISO 11885.

The results are shown in table 5.

TABLE 5
Results on the removal of iron and manganese
from synthetic waste water

| | No. 1 | No. 2 | No. 3 | No. 4 | No. 5 | No. 6 | No. 7 |
|---|---|---|---|---|---|---|---|
| | (Control) | (Invention) | (Comparison) | (Comparison) | (Comparison) | (Invention) | (Comparison) |
| Iron | 55.4 | 0.21 | n.d. | 0.74 | n.d. | n.d. | n.d. |
| (mg/l) | | | | | | | |
| Manganese | 7.5 | 0.18 | n.d. | 0.22 | n.d. | n.d. | n.d. |
| (mg/l) | | | | | | | |

n.d. = not determined

### Example 5

### Treatment of River Water from the Niers (Drinking Water Treatment)

This example illustrates the use of the method according to the invention for drinking water treatment or drinking water preparation. A sample of river water from the Niers was subjected to one of the following two treatments and the turbidity, the alpha color grade, the pH, the alkalinity and the oxidizability were determined before and after the respective treatment:

Treatment 1 (Comparison)

To 500 ml of Niers river water were added 10 ppm of aluminum sulfate and 10 ppm of poly-DADMAC (Sedipur CL 940; ETC Speciality Chemical Distribution) (cationic polymer) and then the mixture was filtered.

Treatment 2 (Invention)

To 500 ml of Niers river water in a 500 ml glass beaker were added 0.1 g/l of activated calcium carbonate (Omya AG, MCC R 450 ME) together with 0.02 g/l of bentonite (Südfloc P62 from SUD-CHEMIE AG) and the mixture was stirred for 30 s at 400 rpm. Then, 10 ppm of Nerolan AG 580 (Nerolan Wassertechnik GmbH, Krefeld, anionic, acrylamide-free polyacrylate) were added and the mixture was stirred for 10 min until sludge separation by means of a fluted filter.

The results are shown in table 6.

TABLE 6
Results regarding the treatment of river water from the Niers

| | Original | After | After |
|---|---|---|---|
| | sample | treatment 1 | treatment 2 |
| Turbidity (mg/ml) | 1.4 | 0.25 | 0.25 |
| Alpha color grade | 32 | 5 | 6 |
| pH | 7.7 | 6.5 | 8.45 |
| Alkalinity (mM) | 0.45 | 0.25 | 0.75 |
| Oxidizability | 7.1 | 3.0 | 3.8 |

The results show that via the method according to the invention a customarily used aluminum salt addition which leads to an undesirably strong lowering of the pH, and the customary addition of the poorly degradable cationic poly-DADMAC can be replaced. In particular, in the method according to the invention, for the same water quality with respect to turbidity and color grade, no lowering of the pH occurs, nor reduction in buffer capacity. This has the advantage that the corrosion of metal conduits can be decreased.

### Example 6

### Treatment of Synthetic Textile Waste Water

To 500 ml of a synthetic textile waste water (drinking water from the mains network, admixed with 9 g of municipal digested sludge and 1 g/l of the dye Simplicol (textile coloring agent)) were added 250 ppm of a mixture of surface-treated calcium carbonate (Omya AG, MCC R 450 ME) (200 ppm) and natural bentonite (Südfloc P62, Süd-Chemie AG) (50 ppm) and the mixture was stirred for 60 s. From the resulting strongly colored and highly turbid starting sample, after filtration, a virtually colorless and readily filterable clear water phase was obtained.

In order to demonstrate the effect of the addition of natural bentonite, in a following experiment, the bentonite fraction was increased by using 250 ppm of a mixture of surface-treated calcium carbonate and natural bentonite in a weight ratio of 4:1.6 instead of 4:1. A colorless and very readily filterable clear water phase was obtained.

1. A method for purification of water or for dewatering sludge, which comprises the steps of:
(a) contacting a surface-treated natural calcium carbonate, a natural bentonite and an anionic polymer with the water or the sludge, wherein, by aggregation of the particulate substances present in the water or sludge, flocs are formed, and
(b) separating off the flocs formed, in order to obtain purified water or separating off water, in order to obtain a dewatered sludge,
wherein the surface-treated natural calcium carbonate is a reaction product of a natural calcium carbonate with an acid and carbon dioxide which is formed in situ during the surface treatment and/or is supplied externally, and wherein the surface-treated natural calcium carbonate is produced as an aqueous suspension having a pH, measured at 20° C., of more than 6.0.

2. The method as claimed in claim 1, wherein the natural calcium carbonate is selected from the group consisting of marble, calcite, chalk, dolomite, limestone and mixtures thereof.

3. The method as claimed in claim 1, wherein the acid has a pKₐ value at 25° C. of less than or equal to 2.5.

4. The method as claimed in claim 1, wherein the natural calcium carbonate is reacted with the acid and/or the carbon dioxide in the presence of at least one compound selected from the group consisting of silicate, silicon dioxide, aluminum hydroxide, alkaline earth metal aluminate, magnesium oxide, and mixtures thereof.

5. The method as claimed in claim 1, wherein the surface-treated natural calcium carbonate has
(i) a specific surface area from 5 to 200 m²/g, measured using nitrogen and the BET method as specified in ISO 9277, and/or
(ii) a weight-average particle diameter from 0.1 to 50 μm, measured according to the sedimentation method, and/or
(iii) an intraparticle porosity from 20 to 40% by volume, measured by means of mercury porosimetry.

6. The method as claimed in claim 1, wherein the natural bentonite is a neutral natural bentonite, for which a suspension of 2 g/10 ml of the neutral natural bentonite in water has a pH from 6.0 to 8.0.

7. The method as claimed in claim 1, wherein the anionic polymer is a natural anionic polymer.

8. The method as claimed in claim 1, wherein
(i) the surface-treated natural calcium carbonate is contacted with the water in an amount of 0.001 to 0.1% by weight, based on the weight of the water, and/or
(ii) the natural bentonite is contacted with the water in an amount of 0.0001 to 0.01% by weight, based on the weight of the water, and/or
(iii) the anionic polymer is contacted with the water in an amount of 0.00001 to 0.001% by weight, based on the weight of the water.

9. The method as claimed in claim 1, wherein
(i) the surface-treated natural calcium carbonate is contacted with the sludge in an amount of 0.005 to 20% by weight, based on the weight of the sludge, and/or
(ii) the natural bentonite is contacted with the sludge in an amount of 0.0005 to 5.0% by weight, based on the weight of the sludge, and/or
(iii) the anionic polymer is contacted with the sludge in an amount of 0.00001 to 0.001% by weight, based on the weight of the sludge.

10. The method as claimed in claim 1, wherein the flocs are separated off by means of filtration, sedimentation or centrifugation.

11. The method as claimed in claim 1, wherein the water is selected from the group consisting of process water, drinking water and waste water, and the sludge is selected from the group consisting of sewage sludge, beet water sludge, sediments from natural waters and harbors, sludge from geological boreholes and the slurry wall construction method, papermaking sludge, oil-containing sludge, sludge from the food industry and aluminum hydroxide-containing sludge.

12. A composition for purification of water or for dewatering sludge which comprises a surface-treated natural calcium carbonate having a specific surface area from 5 to 200 m²/g, measured using nitrogen and the BET method as specified in ISO 9277, and/or a weight-average particle diameter from 0.1 to 50 μm, measured according to the sedimentation method, and/or an intraparticle porosity from 20 to 40% by volume, measured by means of mercury porosimetry;
a neutral natural bentonite, for which a suspension of 2 g/10 ml of the neutral natural bentonite in water has a pH from 6.0 to 8.0; and
an anionic starch, alginate or mixtures thereof.

13. The composition as claimed in claim 12, wherein the weight ratio of the surface-treated natural calcium carbonate and the natural bentonite is in the range from 50:50 to 99:1.

14. (canceled)

15. (canceled)

16. A composition for purification of water or for dewatering sludge which comprises a surface-treated natural calcium carbonate, a natural bentonite and an anionic polymer, wherein the surface-treated natural calcium carbonate is a reaction product of a natural calcium carbonate with an acid and carbon dioxide which is formed in situ during the surface treatment and/or is supplied externally, and wherein the surface-treated natural calcium carbonate is produced as an aqueous suspension having a pH, measured at 20° C., of more than 6.0.

17. The method as claimed in claim 1, wherein the anionic polymer is an anionic starch, alginate or mixtures thereof.

18. The method as claimed in claim 1, wherein the sludge is selected from the group consisting of sewage sludge, beet water sludge, sediments from natural waters and harbors, sludge from geological boreholes and the slurry wall construction method, papermaking sludge, oil-containing sludge, sludge from the food industry and aluminum hydroxide-containing sludge.

19. The method as claimed in claim 1, wherein the water is selected from the group consisting of process water, drinking water and waste water.
